(19) United States
(12) Patent Application Publication
(10) Pub. No.: US 2010/0322127 A1
(43) Pub. Date: Dec. 23, 2010

(54) COMMUNICATION APPARATUS

(75) Inventor: Masaki NAKAJIMA, Kanagawa-ken (JP)

Correspondence Address: HOLTZ, HOLTZ, GOODMAN & CHICK PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/817,423

(22) Filed: Jun. 17, 2010

(30) Foreign Application Priority Data
Jun. 18, 2009 (JP) P2009-145851

(51) Int. Cl. G08C 17/00

(52) U.S. Cl. 370/311

(57) ABSTRACT

A communication apparatus includes a communication control unit which communicates data via a communication network; an application control unit which executes an application; and a suspending unit which is configured to make the application control unit to be in a suspended state. The communication control unit is configured to establish a signaling connection via the communication network by a request from the application control unit, and to release the established signaling connection if the application control unit is in the suspended state. An input section may be provided to receive an input by a user.

### BACKGROUND OF THE INVENTION

1. Field of the Invention

The present invention relates to a mobile communication apparatus, and more particularly to a process of releasing a signaling connection.

2. Description of the Related Art

When an application performed in a mobile communication apparatus performs a communication via a mobile communication network, the apparatus requests a base station controller to establish a signaling connection via a base station. Then, the application performs the communication via the established signaling connection. Further, for the communication with the base station, the application uses a traffic channel allocated by the establishment of the signaling connection. In addition, the channel is a logical channel, and may be a single physical channel or not.

In order to hold the established signaling connection and the traffic channel, power is consumed. In this regard, when a communication is not performed for a predetermined time, the mobile communication apparatus releases the signaling connection and the traffic channel. Due to such release, power consumption is reduced and communication resources are efficiently used (for example, refer to pages 4 and 5 (FIG. 2) of JP-T-2005-510967).

However, according to the method disclosed in JP-T-2005-510967, it is disadvantageous in that the signaling connection must be held for a predetermined time after a communication is not performed.

### SUMMARY OF THE INVENTION

In view of the above, it is an object of the invention to release a signaling connection when it is determined that a communication is not performed.

According to the invention, when it is determined that a communication is not performed, a signaling connection can be released.

### BRIEF DESCRIPTION OF THE DRAWINGS

FIG. 1 is a block diagram illustrating the configuration of a mobile communication apparatus according to an embodiment of the invention;

FIG. 2 is a block diagram illustrating the configuration of a communication-based processing unit according to an embodiment of the invention;

FIG. 3 is a block diagram illustrating the configuration of an application-based processing unit according to an embodiment of the invention;

FIG. 4 is a diagram illustrating one example of the configuration of a release delay time according to an embodiment of the invention; and

FIG. 5 is a flowchart illustrating a signaling connection release operation performed by a connection releasing section according to an embodiment of the invention.

### DETAILED DESCRIPTION OF THE INVENTION

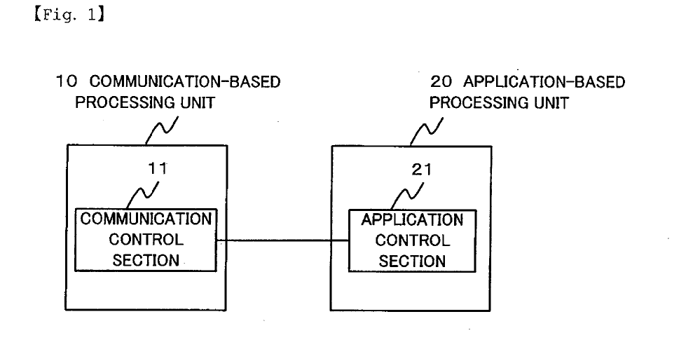

Hereinafter, a mobile communication apparatus according to an embodiment of the invention will be described with reference to the accompanying drawings. FIG. 1 is a block diagram illustrating the configuration of the mobile communication apparatus according to the embodiment of the invention. The mobile communication apparatus includes a communication-based processing unit 10 and an application-based processing unit 20. The communication-based processing unit 10 includes a communication control section 11 and the application-based processing unit 20 includes an application control section 21. The communication control section 11 is connected to the application control section 21.

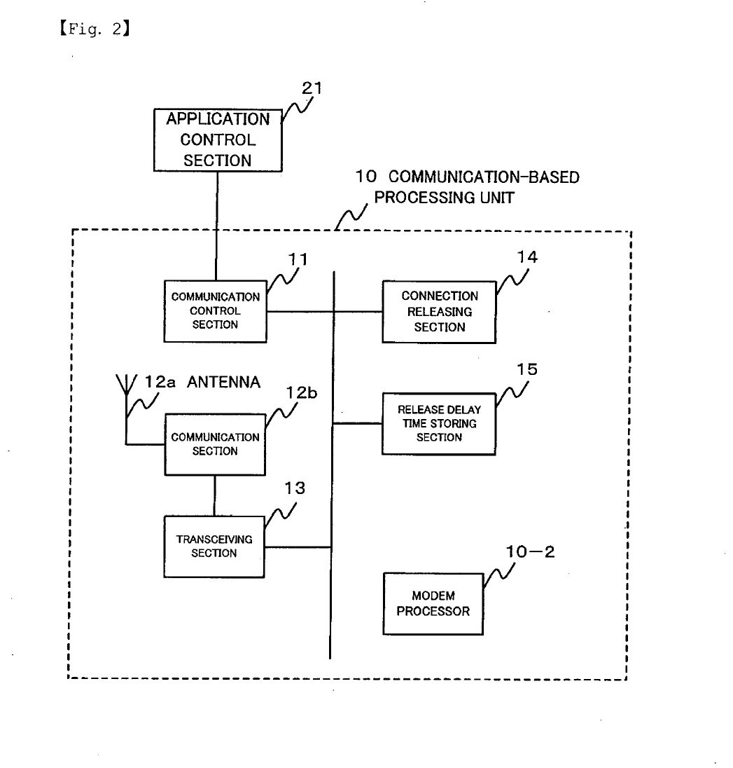

FIG. 2 is a block diagram illustrating the configuration of the communication-based processing unit 10. The communication-based processing unit 10 includes a communication control section 11 for controlling the whole of the communication-based processing unit 10 while being connected to the application control section 21, an antenna 12a for transceiving radio waves between the mobile communication apparatus and a base station (not shown) of a mobile communication network, a communication section 12b, a transceiving section 13, a connection releasing section 14 and a release delay time storing section 15. The release delay time storing section 15 stores a release delay time.

Further, the communication-based processing unit 10 includes a modem processor 10-2. The communication control section 11 and the connection releasing section 14 are formed by a program using the modem processor 10-2.

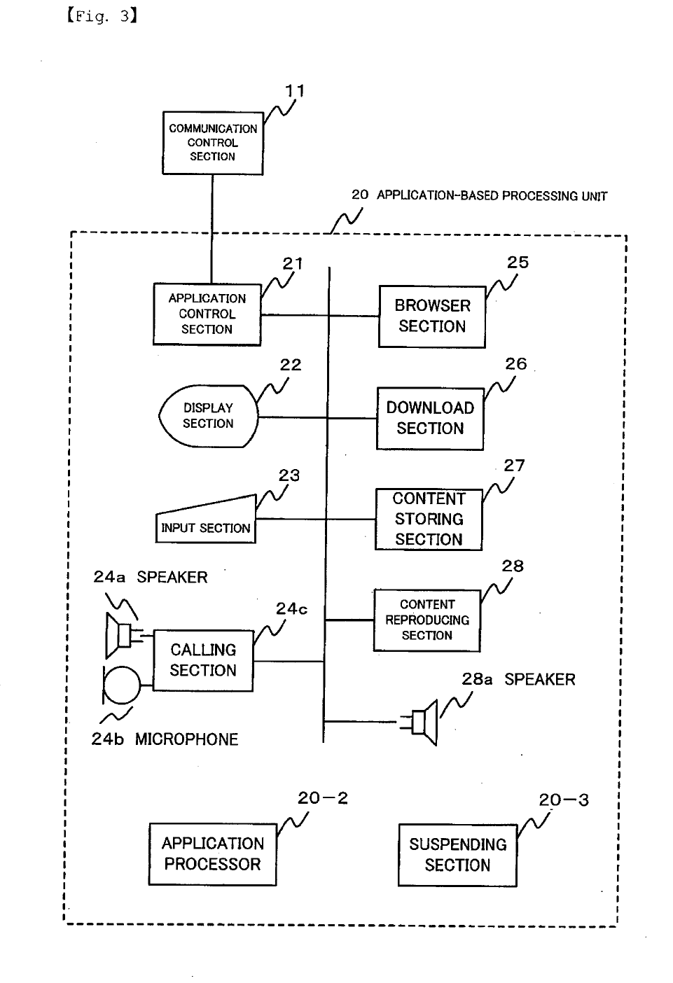

FIG. 3 is a block diagram illustrating the configuration of the application-based processing unit 20. The application-based processing unit 20 includes an application control section 21 for controlling the whole of the application-based processing unit 20 while being connected to the communication control section 11, a display section 22, an input section 23, a speaker 24a for generating a reception voice, a microphone 24b for inputting a transmission voice, a calling section 24c, a browser section 25, a download section 26, a content storing section 27, a content reproducing section 28, and a speaker 28a for reproducing voice included in a content.

Further, the application-based processing unit 20 includes an application processor 20-2 and a suspending section 20-3. The application control section 21, at least a part of the calling section 24c, the browser section 25, the download section 26, and at least a part of the content reproducing section 28 are formed by a program using the application processor 20-2. The suspending section 20-3 allows the application-based processing unit 20 to be in a suspended state and resumes the application-based processing unit 20 from the suspended state to a normal operation state. At least a part of the suspending section 20-3 may be formed by the program using the application processor 20-2.

Hereinafter, operations of each element of the mobile communication apparatus according to the embodiment of the invention will be described with reference to FIGS. 2 and 3.

The communication control section 11 relays a communication of each element of the communication-based processing unit 10 and a communication of each element of the application-based processing unit 20. For example, when an incoming call is received, the communication control section 11 sends the incoming call to the application control section 21. Further, the communication control section 11 controls the transceiving section 13 to transmit an originating call and an incoming call transmitted from the application control section 21.

The communication section 12b outputs a high frequency signal, which is received in the antenna 12a, to the transceiving section 13, and transmits a high frequency signal, which is output from the transceiving section 13, to the antenna 12a.

The transceiving section 13 amplifies, frequency-converts and demodulates the high frequency signal received from the communication section 12b, and sends a signal resulting from the above process to each element of the apparatus. For example, the transceiving section 13 sends a control signal to the communication control section 11. Further, the transceiving section 13 modulates, frequency-converts and amplifies a signal transmitted from each element of the apparatus, for example, the control signal transmitted from the communication control section 11, and sends a high frequency signal resulting from the above process to the communication section 12b.

In addition, the transceiving section 13 receives originating requests from each element of the apparatus. When a signaling connection is not established, the transceiving section 13 requests a base station controller (not shown) to establish the signaling connection via a base station. Then, the transceiving section 13 performs a communication via the established signaling connection. Further, for the communication with the base station, the transceiving section 13 uses a traffic channel allocated by the establishment of the signaling connection.

Moreover, if an incoming call is received from the base station, the transceiving section 13 performs a communication via the specified signaling connection in response to the incoming call. Further, for the communication with the base station, the transceiving section 13 uses a traffic channel allocated therethrough. When such a communication is performed by a mobile communication network, that is, receiving data to browser section 25 and the download section 26, and when the application-based processing unit 20 is in the suspended state, after the application-based processing unit 20 is resumed from the suspending section 20-3, a communication is performed.

Herein, the transceiving section 13 stores the signaling connection and the traffic channel in connection with each element of the apparatus related to the signaling connection and the traffic channel.

The transceiving section 13 sends a digital voice signal, which is received via a communication traffic channel allocated as described above, to the calling section 24c, sends an Internet content signal, which is received via a traffic channel for a packet, to the browser section 25, and sends a content signal to the download section 26. Further, the transceiving section 13 transmits a digital voice signal, which is output from the calling section 24c, via the communication traffic channel, and transmits a Web access signal, which is output from the browser section 25, and a download control signal, which is output from the download section 26, via the traffic channel for a packet. As described above, the communication includes a call communication through the calling section 24c and a packet communication through the browser section 25 and the download section 26.

When the application-based processing unit 20 is in the suspended state, the connection releasing section 14 releases the signaling connection related to the browser section 25 and the download section 26 included in the application-based processing unit 20. For example, such release is performed by requesting the transceiving section 13 to transmit a SCRI (Signaling Connection Release Indication) message, which is defined in 3GPP TS25. 331 CR3483, to the base station controller.

Further, as the signaling connection is released, a traffic channel corresponding to the connection is released. However, the release of the channel is not always limited to release of a physical channel. When releasing the traffic channel, the connection releasing section 14 refers to a release delay time stored in the release delay time storing section 15.

The application control section 21 relays a communication of each element of the application-based processing unit 20 and a communication of each element of the communication-based processing unit 10. For example, when an incoming call is received from the communication control section 11, the application control section 21 informs of the reception of the incoming call by allowing sound, which is generated by reproduction of a predetermined sound content in the content reproducing section 28, to be output from the speaker 28a and allowing a predetermined call termination notification image to be displayed on the display section 22. Further, when a call termination operation or a call originating operation is performed through a predetermined manipulation of the input section 23, the application control section 21 sends an incoming call or an originating call to the communication control section 11.

The display section 22 includes an LCD attached to a backlight, which is used for a display demanding a manipulation by a user, a display of a content manipulation by the user, a display of an operation state of the apparatus, and the like. The display section 22 displays image data including characters including a cursor and numerals with the maximum luminance under the control of the application control section 21, and the displayed data is switched through an input manipulation from the input section 23 or instruction from the application control section 21 in response to the incoming call.

Further, when a key manipulation of the input section is not performed for a predetermined time or when a predetermined key of the input section 23 is operated, the display screen of the display section 22 is transited to a power consumption saving mode by the application control section 21. That is, the display section 22 is turned off. Further, the transition to the power saving mode is not performed when the display content of the display section 22 is changed regardless of the key manipulation of the input section 23. For example, when the content reproducing section 28 reproduces a moving image content on the display section 22, such transition is not performed. Further, when the display content of the display section 22 is changed regardless of the key manipulation of the input section 23, a normal display mode is performed. For example, when the predetermined call termination notification image is displayed by the application control section 21, the normal display mode is performed. And In the case in which the apparatus is in the power saving mode, when a predetermined power saving mode release key of the input section 23 is operated and when a predetermined resume signal is received from the communication control section 11, the application control section 21 resumes the apparatus in the power saving mode.

The input section 23 includes keys having a plurality of function keys such as numeral keys for designating phone numbers of communication partners and inputting Hiragana characters, alphabetic characters and symbolic characters through a toggle-type input method, cursor shift keys or scroll keys. If the key of the input section 23 is pressed down, an identifier of the key is notified to the application control section 21, so that the identifier is displayed as a character on the display section 22 or is controlled by the application control section 21.

The calling section 24c converts the digital voice signal output from the transceiving section 13 into an analog voice signal, amplifies the analog voice signal, and sends the amplified analog voice signal to the speaker 24a. Further, the calling section 24c amplifies an analog voice signal, which is output from the microphone 24b, converts the analog voice signal into a digital voice signal, and transmits the digital voice signal to the transceiving section 13.

The browser section 25 accesses a Web server (not shown) identified by a Webpage address designated by a predetermined key manipulation of the input section 23, allows still images, moving images and characters of an Internet content signal, which are stored in the Web server, to be displayed on the display section 22, and allows sound to be generated from the speaker 24a or 28a. Consecutively, the browser section 25 displays or generates an Internet content signal transmitted according to a predetermined key manipulation of the input section 23.

The operation of the browser section 25 is ended by a key manipulation representing the ending of the input section 23. Further, the browser section 25 releases a signaling connection by the key manipulation of the input section 23, which represents signaling connection release. Herein, the key manipulation representing the ending and the key manipulation representing the signaling connection release may be a single manipulation or individual manipulations.

The download section 26 accesses a download server (not shown) designated by a predetermined key manipulation of the input section 23, receives a content stored in the download server, and stores the content in the content storing section 27. The content includes still images, moving images, characters, and a part or the whole of sound. The operation of the download section 26 is ended by the key manipulation representing the ending of the input section 23. Further, the download section 26 releases a signaling connection by the key manipulation of the input section 23, which represents the signaling connection release. Herein, the key manipulation representing the ending and the key manipulation representing the signaling connection release may be a single manipulation or individual manipulations.

The content reproducing section 28 reproduces the content stored in the content storing section 27. That is, the content reproducing section 28 allows the still images, the moving images and the characters, which are included in the content, to be displayed on the display section 22, and allows sound to be generated from the speaker 28a.

When a predetermined suspend key of the input section 23 is operated or it is determined that the apparatus is left unused for a predetermined time, the suspending section 20-3 allows the application-based processing unit 20 to be in the suspended state. When the predetermined suspend key is operated, the suspending section 20-3 immediately allows the application-based processing unit 20 to be in the suspended state regardless of the operation of each element or the operation state thereof. However, during a predetermined operation of the application-based processing unit 20, for example, during an operation of the calling section 24c, the suspending section 20-3 does not allow the application-based processing unit 20 to be in the suspended state. Thereafter, when the operation of the calling section 24c is ended, the suspending section 20-3 may allow the application-based processing unit 20 to be in the suspended state or not.

When the key manipulation of the input section 23 is not performed over a predetermined non-manipulation time threshold value, the suspending section 20-3 determines that the apparatus is left unused. Further, during an operation of a processing section continuing to operate without the key manipulation of the input section 23, the suspending section 20-3 determines that the apparatus is not left unused regardless of the key manipulation thereof. One example of such a processing section is the download section 26 continuing to receive content without the key manipulation thereof.

In addition, when the operation of such a processing section is ended regardless of normal ending or abnormal ending, it does not disturb the determination that the apparatus is left unused. For example, when the download section 26 does not receive the content for a predetermined time and the operation of the download section 26 is abnormally ended by timeout, it does not disturb the determination that the apparatus is left unused. Further, when the operation is in a stop state or an idle state, it does not disturb the determination that the apparatus is left unused.

Furthermore, the suspended state represents that power supply to at least the application processor 20-2 is interrupted, and information stored in a primary storing section (not shown), which is accessed by the application processor 20-2, is held. The suspended state is not limited to the above configuration and various types of modification can be made. The information may be held by continuously supplying power to the volatile primary storing section, or storing the information in a non-volatile secondary storing section (not shown). The information may be held, so that all states of a program and the like, which uses the application processor 20-2, are held as it is, and a processing section, which is being operated before entering the suspended state, is continuously stored as a continuous operation state.

In the case in which the application-based processing unit 20 is in the suspended state, when a predetermined suspend release key of the input section 23 is operated and when a predetermined resume signal is received from the communication control section 11, the suspending section 20-3 resumes the application-based processing unit 20 in the suspended state. Herein, the resumption represents that power is supplied again to a part in the suspended state, to which power has not been supplied, and the part is in a normal operation state.

Even if the application-based processing unit 20 is in the suspended state, since the information stored in the primary storing section is held, the application-based processing unit 20 returns to a state up to just before the application-based processing unit 20 is in the suspended state, and then operates through the resumption. Thus, the application-based processing unit 20 is allowed to be in the suspended state, so that power consumption can be significantly reduced and a user does not feel uncomfortable with respect to the operation of the apparatus.

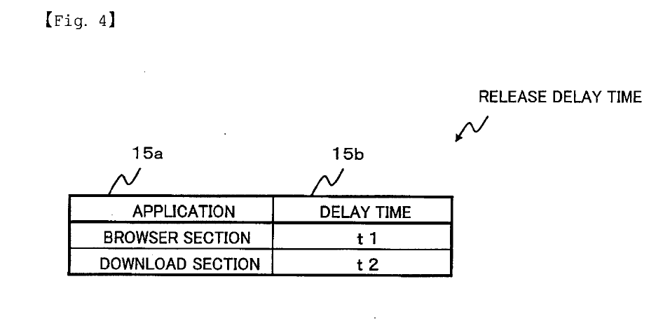

Next, the release delay time stored in the release delay time storing section 15 will be described with reference to one example shown in FIG. 4. The release delay time denotes information related to an application 15a and a delay time 15b. The application 15a is an application section in the application-based processing unit 20 and serves as a “browser section” and a “download section”. The delay time 15b denotes a time until a signaling connection is released after the application-based processing unit 20 is in the suspended state during the operation of the application 15a, in other words, when the signaling connection related to a communication of the application 15a has been established. The delay time 15b is zero or a positive number.

Preferably, t1, which is the delay time 15b related to the application 15a serving as the “browser section”, is a small number, for example, zero. This is because, when the application-based processing unit 20 is in the suspended state, a user of the apparatus does not perform the key manipulation of the input section 23 with respect to the browser section 25, and thus an access communication to the Web server is not performed. In this regard, although a communication of an Internet content signal from the Web server has been performed, there is a high possibility that the communication was not intended by a user of the apparatus, and no obstruction is caused by release of a signaling connection in a short time.

Meanwhile, preferably, t2, which is the delay time 15b related to the application 15a serving as the “download section”, is a number larger than t1. This is because, when the application-based processing unit 20 is in the suspended state, it is understood that a user of the apparatus intends to allow the download section 26 to continuously perform a download operation. In this regard, preferably, t2 is set as a timeout time at which it is determined that abnormality has occurred in the download of the download section 26, that is, a time at which the operation of the download section 26 is ended when a content signal is not received over the timeout time.

In the case in which t2 is a small number, as a result of the reception of the content signal after the application-based processing unit 20 is in the suspended state, release and establishment of a signaling connection related to the download section 26 may be frequently repeated and power consumption of the mobile communication apparatus may be increased. In addition, resources of an apparatus constituting a mobile communication network may be inefficiently used.

Further, for example, when traffic congestion occurs in a mobile communication network, re-establishment of a signaling connection is delayed, and the operation of the download section 26 is ended by timeout, that is, non-reception of the content signal for a predetermined time, so that download may not be completed.

Meanwhile, if the appropriate delay time 15b is stored, the suspending section 20-3 determines that the apparatus is left unused when the key manipulation of the input section 23 is not performed over a short non-manipulation time threshold value, and allows the application-based processing unit 20 to be in the suspended state. In other words, even if the application-based processing unit 20 is frequently in the suspended state, establishment and release of a signaling connection are performed without interruption.

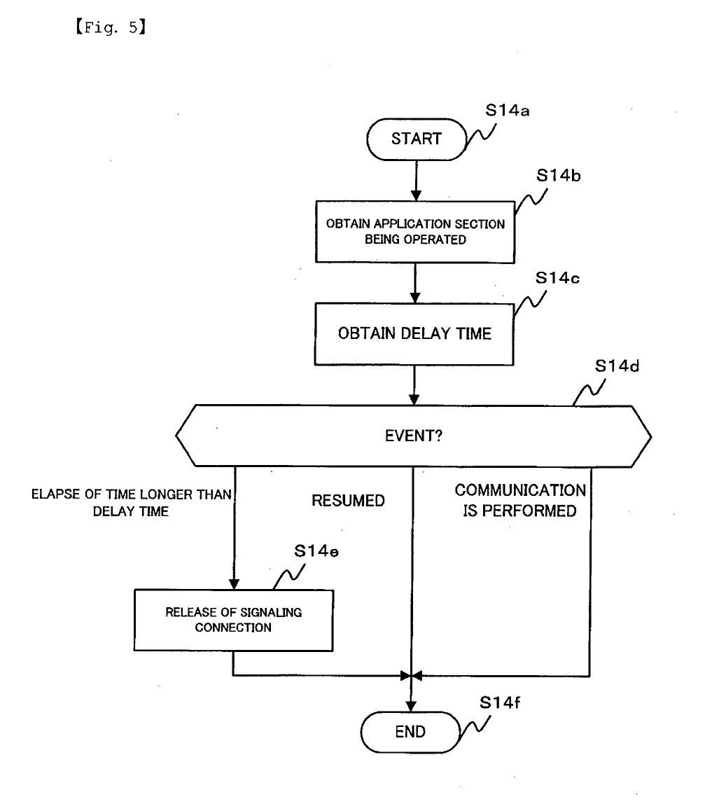

Next, a signaling connection release operation performed by the connection releasing section 14 in the mobile communication apparatus having the above configuration will be described with reference to the flowchart shown in FIG. 5. The connection releasing section 14 starts to operate when the application-based processing unit 20 is in the suspended state (Step S14a). The communication control section 11 detects whether the application-based processing unit 20 is in the suspended state by communicating with the application control section 21 at a predetermined time interval to check the state of the application-based processing unit 20. When the application-based processing unit 20 is in the suspended state, there is no reply from the application control section 21.

Next, the connection releasing section 14 obtains an application section being operated (Step S14b). The application section is obtained as an application section related to an established signaling connection. Then, the connection releasing section 14 obtains the delay time 15b, which is related to the application 15a serving as the obtained application section, with reference to the release delay time (Step S14c).

Thereafter, the connection releasing section 14 waits for the generation of an event and separately performs an operation according to the generated event (Step S14d). When the event has been generated after the application-based processing unit 20 is in the suspended state and a time longer than the obtained delay time 15b lapses, the connection releasing section 14 releases the established signaling connection (Step S14e), thereby completing the signaling connection release operation (Step S14f).

Meanwhile, when the event has been generated by the resumption of the application-based processing unit 20 or a communication via the signaling connection, the connection releasing section 14 completes the signaling connection release operation (Step S14f).

In the above description, it is assumed that the application section obtained in step S14b is one. However, the invention is not limited thereto. When a plurality of application sections are obtained, the connection releasing section 14 selects the longest one of the delay time 15b related to the application 15a corresponding to the respective application sections in step S14c.

In the above description, the communication control section 11 detects whether the application-based processing unit 20 is in the suspended state by communicating with the application control section 21 at the predetermined time interval. However, the invention is not limited thereto. When the application-based processing unit 20 is allowed to be in the suspended state and when the application-based processing unit 20 is resumed, the suspending section 20-3 may notify the communication control section 11 of the respective facts. Further, when notifying the fact that the application-based processing unit 20 is allowed to be in the suspended state, the suspending section 20-3 may notify an application section being operated at that time. According to the above operation, the connection releasing section 14 can obtain the application section of step S14b through the above notification.

In the above description, the connection releasing section 14 determines whether to release a signaling connection with reference to the release delay time stored in the release delay time storing section 15.

However, the invention is not limited thereto. When the delay time 15b related to an application section being operated is not stored, it may be possible to refer to an assumed delay time.

In the above description, the connection releasing section 14 employs all signaling connections related to an application section being operated as objects to be released, and employs all traffic channels corresponding to the connections as objects to be released.

However, the invention is not limited thereto.

For example, when a consumed power value, which is required for holding a signaling connection or a traffic channel, is calculated and the power value is equal to or larger than a predetermined power threshold value, the connection releasing section 14 may release the signaling connection or the traffic channel. According to the above process, for example, when the traffic channel is not an individual physical channel and is allocated to a common physical channel, the connection releasing section 14 does not release the channel, so that a load required for processing the apparatus constituting a mobile communication network can be prevented from being increased.

In the above description, the connection releasing section 14 starts to operate when the application-based processing unit 20 is in the suspended state.

However, the invention is not limited thereto. For example, when the key manipulation of the input section 23 is not performed for a predetermined time and the display screen of the display section 22 is transited to the power consumption saving mode, that is, when the display section 22 is turned off, the connection releasing section 14 may start to operate.

An operation according to the transition to the power saving mode can be applied to the case in which the apparatus is not divided into the communication-based processing unit 10 and the application-based processing unit 20, that is, when the apparatus is operated by a single CPU. The invention is not limited to the above configuration and various types of modification can be made.

What is claimed is:

1. A communication apparatus comprising:
a communication control unit configured to communicate data via a communication network;
an application control unit configured to execute a application;
a suspending unit configured to make the application control unit to be in a suspended state;
wherein the communication control unit configured to establish a signaling connection via the communication network by a request from the application control unit and to release the established signaling connection if the application control unit is in the suspended state.

2. The communication apparatus of claim 1, further comprising an input section configured to receive an input by an user,
wherein if the input section received a predetermined operation, the suspending unit makes the application control unit to be in the suspended state.

3. The communication apparatus of claim 1, further comprising an input unit configured to receive an input by an user,
wherein if the input unit does not receive the input for a predetermined time, the suspending unit makes the application control unit to be in the suspended state.

4. The communication apparatus of claim 1, wherein if the communication control unit does not communicate data via the communication network by the established signaling connection for a predetermined time in the suspended state, the communication control unit releases the established signaling connection.

5. The communication apparatus of claim 1, wherein if the suspending section does not resume the application control unit in the suspended state for a predetermined time in the suspended state, the communication control unit releases the established signaling connection.

6. The communication apparatus of claim 4, wherein the predetermined time differs from one application to another.

7. A communication apparatus comprising:
a communication control unit configured to communicate data via a communication network;
an application control unit configured to execute an application;
a power consumption saving control unit configured to make the apparatus to be in a power consumption saving mode;
wherein the communication control unit configured to establish a signaling connection via the communication network by a request from the application control unit and to release the established signaling connection if the apparatus is in the power consumption saving mode.

8. The communication apparatus of claim 7, further comprising an input unit configured to receive an input by an user,
wherein if the input unit received a predetermined operation, the power consumption saving control unit makes the apparatus to be in the power consumption saving mode

9. The communication apparatus of claim 7, further comprising an input unit configured to receive an input by an user,
wherein if the input unit does not receive the input for a predetermined time, the power consumption saving control unit makes the apparatus to be in the power consumption saving mode.

10. The communication apparatus of claim 7, wherein if the communication control unit does not communicate data via the communication network by the established signaling connection for a predetermined time in the power consumption saving mode, the communication control unit releases the established signaling connection.

11. The communication apparatus of claim 7, wherein if a power consumption saving control unit does not resume the apparatus in the suspended state for a predetermined time in the suspended state, the communication control unit releases the established signaling connection.

12. The communication apparatus of claim 10, wherein the predetermined time differs from one application to another.

13. A mobile communication apparatus comprising:
a mobile communication control unit configured to communicate data via a communication network;
an application control unit configured to execute an application;
a power consumption saving control unit configured to make the apparatus to be in a power consumption saving mode;
wherein the communication control unit configured to establish a signaling connection via the communication network by a request from the application control unit and to release the established signaling connection if the apparatus is in the power consumption saving mode.

14. The mobile communication apparatus of claim 13, further comprising an input unit configured to receive an input by an user,
wherein if the input unit received a predetermined operation, the power consumption saving control unit makes the apparatus to be in the power consumption saving mode

15. The mobile communication apparatus of claim 13, further comprising an input unit configured to receive an input by an user,
wherein if the input unit does not receive the input for a predetermined time, the power consumption saving control unit makes the apparatus to be in the power consumption saving mode.

16. The mobile communication apparatus of claim 13, wherein if the communication control unit does not communicate data via the communication network by the established signaling connection for a predetermined time in the power consumption saving mode, the communication control unit releases the established signaling connection.

17. The mobile communication apparatus of claim 13, wherein if a power consumption saving control unit does not resume the apparatus in the suspended state for a predetermined time in the suspended state, the communication control unit releases the established signaling connection

18. The mobile communication apparatus of claim 16, wherein the predetermined time differs from one application to another.
